(19) United States
(12) Patent Application Publication
(10) Pub. No.: US 2013/0271440 A1
(43) Pub. Date: Oct. 17, 2013

(54) ORGANIC LIGHT EMITTING DIODE DISPLAY AND TESTING METHOD THEREOF

(71) Applicants: Guan hai JIN, Yongin-City (KR); Jae-Beom CHOI, Yongin-City (KR); Kwan-Wook JUNG, Yongin-City (KR); June-Woo LEE, Yongin-City (KR); Hae-Yeon LEE, Yongin-City (KR); Moo-Jin KIM, Yongin-City (KR)

(72) Inventors: Guan hai JIN, Yongin-City (KR); Jae-Beom CHOI, Yongin-City (KR); Kwan-Wook JUNG, Yongin-City (KR); June-Woo LEE, Yongin-City (KR); Hae-Yeon LEE, Yongin-City (KR); Moo-Jin KIM, Yongin-City (KR)

(21) Appl. No.: 13/611,644

(22) Filed: Sep. 12, 2012

(30) Foreign Application Priority Data
Apr. 16, 2012 (KR) 10-2012-0039167

(51) Int. Cl. G09G 5/00; G09G 3/30

(52) U.S. Cl. 345/211; 345/76

(57) ABSTRACT

An organic light emitting diode display includes a substrate, a first pixel and a second pixel on the substrate, the first pixel and the second pixel have different sizes, a first driving voltage line and a second driving voltage line connected to the first pixel and the second pixel, respectively, and the first driving voltage line is capable of applying a first driving voltage to the first pixel and the second driving voltage line is capable of applying a second driving voltage to the second pixel. The second pixel is bigger than the first pixel, and the second driving voltage is less than the first driving voltage.

### CROSS-REFERENCE TO RELATED APPLICATION

This application claims priority under 35 U.S.C. §119 to Korean Patent Application No. 10-2012-0039167, filed in the Korean Intellectual Property Office on Apr. 16, 2012, the entire contents of which are incorporated herein by reference.

### BACKGROUND

An organic light emitting diode (OLED) display includes two electrodes and an organic emission layer disposed therebetween. Electrons injected from one electrode and holes injected from the other electrode are coupled with each other on the organic emission layer to form excitons, and the excitons emit light while emitting energy.

### SUMMARY

Embodiments may be realized by providing an organic light emitting diode display that includes a substrate; a first pixel and a second pixel formed on the substrate and having different sizes; and a first driving voltage line and a second driving voltage line connected to the first pixel and the second pixel, and applying a first driving voltage and a second driving voltage to the first pixel and the second pixel. The second pixel is bigger than the first pixel, and the second driving voltage is less than the first driving voltage.

The first pixel and the second pixel may have the same sizes as pixel electrodes formed in the first pixel and the second pixel. The first pixel may include a red pixel and a green pixel, and the second pixel may include a blue pixel. The red pixel and the green pixel may be the same size.

The organic light emitting diode display may further include a gate line for applying a gate signal to the first pixel and the second pixel; an interlayer insulating layer for covering the gate line; and a data line crossing the gate line to be formed on the interlayer insulating layer, and applying a data signal to the first pixel and the second pixel. The first driving voltage line may include a first horizontal driving voltage line formed in parallel with the gate line and formed in the same layer as the gate line, and a first vertical driving voltage line formed to be vertical with respect to the first horizontal driving voltage line and formed in the same layer as the data line.

The first horizontal driving voltage line may be connected to the first vertical driving voltage line through a first contact hole formed in the interlayer insulating layer. The second driving voltage line may include a second horizontal driving voltage line formed in parallel with the first horizontal driving voltage line and formed in the same layer as the first horizontal driving voltage line, and a second vertical driving voltage line formed to be vertical with respect to the second horizontal driving voltage line and formed in the same layer as the first vertical driving voltage line.

The second horizontal driving voltage line may be connected to the second vertical driving voltage line through a second contact hole formed in the interlayer insulating layer. The organic light emitting diode display may further include a first external connection line formed in the same layer as the first vertical driving voltage line and connected to an external first driving voltage source.

The organic light emitting diode display further may include a first connection bridge formed in the same layer as the first horizontal driving voltage line, and connecting an end of the first vertical driving voltage line and the first external connection line. The organic light emitting diode display may further include a second horizontal connection line formed in the same layer as the second vertical driving voltage line, connecting the second vertical driving voltage line, and formed in parallel with the second horizontal driving voltage line.

The first connection bridge may cross the second horizontal connection line in an insulated manner. The organic light emitting diode display may further include a second external connection line formed in the same layer as the second vertical driving voltage line and connected to an external second driving voltage source.

The organic light emitting diode display may further include a second connection bridge formed in a same layer as the second horizontal driving voltage line and connecting the second horizontal connection line and the second external connection line. The second connection bridge may cross the first external connection line in an insulated manner.

Embodiments may also be realizing by providing a method for testing an organic light emitting diode display that includes manufacturing an organic light emitting diode display in which a first pixel and a second pixel that is bigger than the first pixel are formed on a substrate, and a first driving voltage line and a second driving voltage line for applying a first driving voltage and a second driving voltage with different sizes are formed in the first pixel and the second pixel; providing a modulator for an array test on the organic light emitting diode display; and performing an array test by applying the second driving voltage that is less than the first driving voltage to a second pixel of the organic light emitting diode display.

The first pixel may include a red pixel and a green pixel, and the second pixel may include a blue pixel.

### BRIEF DESCRIPTION OF THE DRAWINGS

FIG. 1 shows an equivalent circuit of an organic light emitting diode display according to an exemplary embodiment.

FIG. 2 shows a layout view of an exemplary pixel of an organic light emitting diode display and a driving voltage line.

FIG. 3 shows a cross-sectional view of a pixel array, according to an exemplary embodiment.

FIG. 4 shows a cross-sectional view with respect to a line IV-IV shown in FIG. 3.

FIG. 5 shows a cross-sectional view with respect to a line V-V shown in FIG. 3.

FIG. 6 shows a process for processing an array test by using an organic light emitting diode display according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” or “connected to” another layer or substrate, it can be directly on or directly connected to the other layer or substrate, or intervening layers may also be present. Like reference numerals refer to like elements throughout.

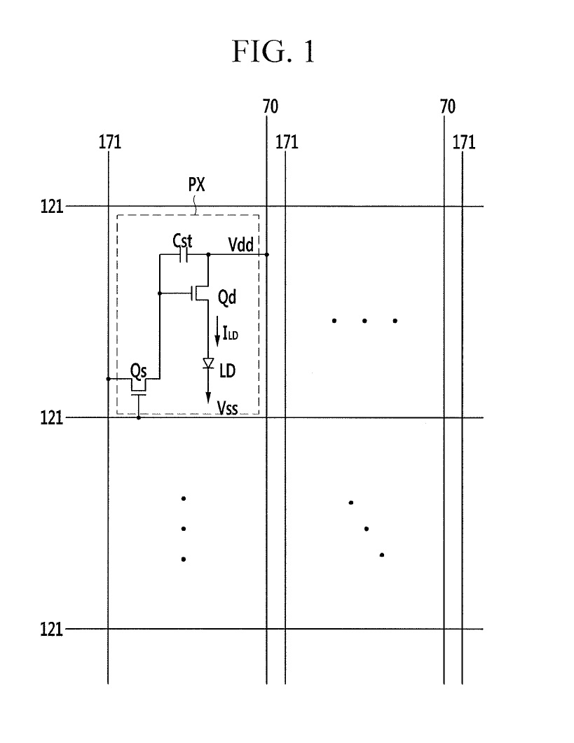

FIG. 1 shows an equivalent circuit of an organic light emitting diode display according to an exemplary embodiment.

Referring to FIG. 1, the organic light emitting diode display includes a plurality of signal lines (121, 171, 70) and a plurality of pixels (PX) connected thereto and arranged in a matrix form to form a pixel array.

The signal lines include a plurality of gate lines 121 for transmitting a gate signal (or a scan signal), a plurality of data lines 171 for transmitting a data signal, and a plurality of driving voltage lines 70 for transmitting a driving voltage (Vdd). The gate lines 121 may be substantially extended in a row direction and may be substantially in parallel with each other. Vertical portions of the data lines 171 and the driving voltage lines 70 may be substantially extended in a column direction and may be substantially in parallel with each other.

The pixel (PX) includes a switching thin film transistor (Qs), a driving thin film transistor (Qd), a storage capacitor (Cst), and an organic light emitting diode (LD).

The switching thin film transistor (Qs) includes a control terminal connected to the gate line 121, an input terminal connected to the data line 171, and an output terminal connected to the driving thin film transistor (Qd). The switching thin film transistor (Qs) transmits the data signal applied to the data line 171 to the driving thin film transistor (Qd) in response to the scan signal applied to the gate line 121.

The driving thin film transistor (Qd) includes a control terminal connected to the switching thin film transistor (Qs), an input terminal connected to the driving voltage line 172, and an output terminal connected to the organic light emitting diode (OLED) (LD). The driving thin film transistor (Qd) outputs an output current (ILD) that is variable by a voltage between the control terminal and the output terminal.

The capacitor (Cst) is connected between the control terminal and the input terminal of the driving thin film transistor (Qd). The capacitor (Cst) charges the data signal applied to the control terminal of the driving thin film transistor (Qd) and maintains it when the switching thin film transistor (Qs) is turned off.

The organic light emitting diode (LD) includes an anode connected to the output terminal of the driving thin film transistor (Qd) and a cathode connected to a common voltage (Vss). The organic light emitting diode (LD) emits light by differentiating the intensity according to the output current (ILD) of the driving thin film transistor (Qd) and displays the image.

The switching thin film transistor (Qs) and the driving thin film transistor (Qd) may be n-channel field effect transistors (FETs). Further, at least one of the switching thin film transistor (Qs) and the driving thin film transistor (Qd) may be a p-channel field effect transistor. Also, the connection states of the thin film transistors (Qs, Qd), the capacitor Cst, and the organic light emitting diode (LD) are changeable.

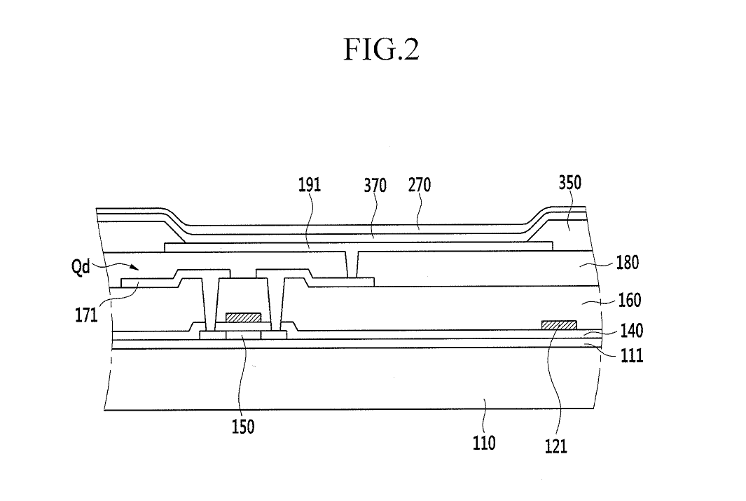

A detailed configuration of the organic light emitting diode display shown in FIG. 1 will now be described with reference to FIG. 2 to FIG. 5.

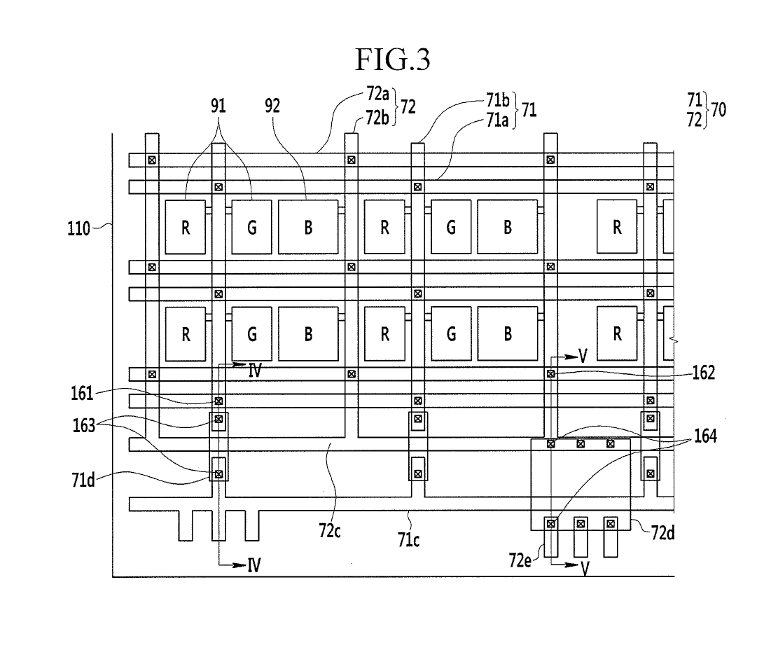

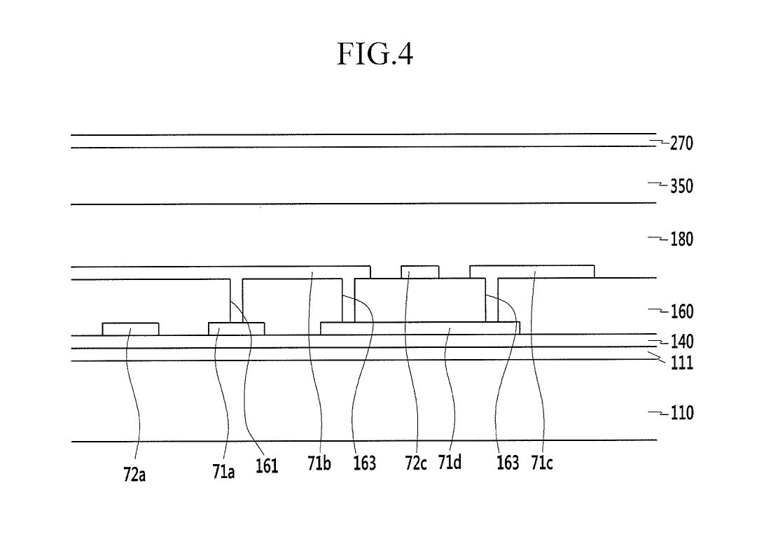

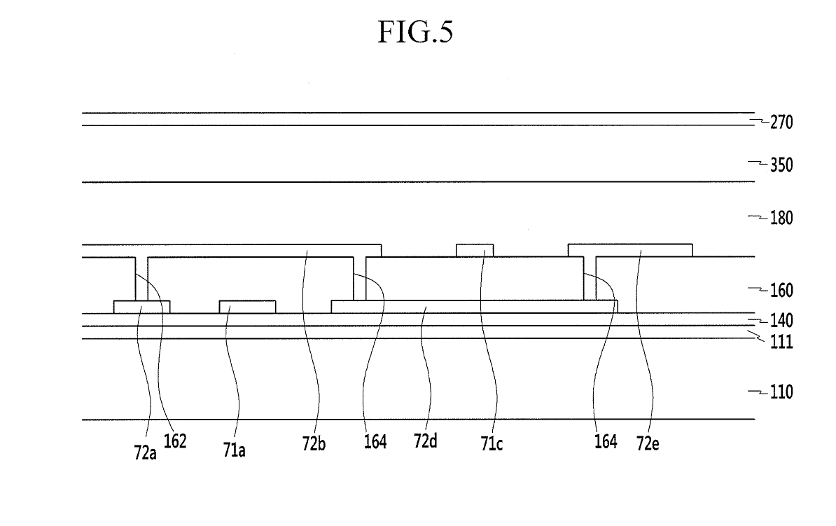

FIG. 2 shows a layout view of a pixel of an organic light emitting diode display according to an exemplary embodiment and a driving voltage line, FIG. 3 shows a cross-sectional view of a pixel array according to a pixel in FIG. 2, FIG. 4 shows a cross-sectional view with respect to a line IV-IV shown in FIG. 3, and FIG. 5 shows a cross-sectional view with respect to a line V-V shown in FIG. 3.

As shown in FIG. 2 and FIG. 3, the organic light emitting diode display includes a substrate 110, first pixels 91, and second pixels 92 that are formed on the substrate 110 and have different sizes with respect to each other, and a first driving voltage line 71 and a second driving voltage line 72 connected to the first pixels 91 and the second pixels 92, respectively.

A layered structure of the first pixel 91 and the second pixel 92 of the organic light emitting diode display according to the exemplary embodiment will now be described.

As shown in FIG. 2, regarding the first pixel 91 and the second pixel 92 of the organic light emitting diode display, a buffer layer 111 is formed on the substrate 110 made of transparent glass or plastic, a semiconductor layer 150 is formed on the buffer layer 111, a gate insulating layer 140 is formed on the semiconductor layer 150, and a gate line 121 for transmitting a gate signal (or a scan signal) is formed on the gate insulating layer 140. An interlayer insulating layer 160 is formed on the gate line 121, and a data line 171 crossing the gate line 121 and transmitting the data signal is formed on the interlayer insulating layer 160. The semiconductor layer 150, the gate line 121, and the data line 171 form the driving thin film transistor (Qd).

A protective layer 180 made of an inorganic material or an organic material is formed on the driving thin film transistor (Qd). When the protective layer 180 is made of the organic material, its surface can be flat. A pixel electrode 191 connected to the driving thin film transistor (Qd) and made of a transparent conductor such as ITO or IZO is formed on the protective layer 180. A pixel defining layer 350 made of an organic film is formed on the pixel electrode 191. The pixel defining layer 350 includes an opening that surrounds an edge of the pixel electrode 191 and exposes the pixel electrode 191.

An organic light emitting member 370 is formed on the pixel defining layer 350. The organic light emitting member 370 may include an auxiliary layer (not shown) for improving luminous efficiency of an emission layer in addition to an organic emission layer for emitting light. The auxiliary layer can be at least one of an electron transport layer (ETL), a hole transport layer (HTL), an electron injection layer (EIL), and a hole injection layer (HIL).

A common electrode 270 is formed on the organic light emitting member 370. The common electrode 270 can be made of a metal with high reflectivity. The common electrode 270 is formed on the whole surface of the substrate, and forms a pair with the pixel electrode 191 to provide a current to the organic light emitting member 370.

The pixel electrode 191, the organic light emitting member 370, and the common electrode 270 form the organic light emitting diode (LD), and the pixel electrode 191 can be an anode and the common electrode 270 can be a cathode, or the pixel electrode 191 can be a cathode and the common electrode 270 can be an anode.

As shown in FIG. 2 to FIG. 5, a plurality of driving voltage lines 70 for applying a driving voltage are formed on the pixel electrode 191. The plurality of driving voltage lines 70 include the first driving voltage line 71 and the second driving voltage line 72 for applying the first driving voltage and the second driving voltage to the first pixel 91 and the second pixel 92, respectively.

The second pixel 92 is bigger than the first pixel 91. The first pixel 91 and the second pixel 92 may have the same configuration, e.g., in terms of relative size, with respect to the pixel electrode 191 formed in the first pixel 91 and the second pixel 92.

The first pixel 91 can be a red pixel (R) and a green pixel (G), and the second pixel 92 can be a blue pixel (B). Sizes of the red pixel (R) and the green pixel (G) in the first pixel 91 may be the same. The sizes of the red pixel (R) and the green pixel (G) may be smaller than the size of the blue pixel (B).

The first driving voltage line 71 connected to the first pixel 91 includes a first horizontal driving voltage line 71a formed to be substantially parallel to the gate line 121, and a first vertical driving voltage line 71b formed to be vertical, e.g., above, and to extend in direction that intersects, e.g., is substantially perpendicular to, the first horizontal driving voltage line 71a.

The first horizontal driving voltage line 71a is formed on the same layer as the gate line 121, and the first vertical driving voltage line 71b is formed on the same layer as the data line 171. The interlayer insulating layer 160 is formed between the first horizontal driving voltage line 71a and the first vertical driving voltage line 71b. The first horizontal driving voltage line 71a is connected to the first vertical driving voltage line 71b through a first contact hole 161 formed in the interlayer insulating layer 160.

A first external connection line 71c is formed on the same layer as the first vertical driving voltage line 71b, and the first external connection line 71c is connected to an external first driving voltage source (not shown). Therefore, the first external connection line 71c receives a first driving voltage from the first driving voltage source.

A first connection bridge 71d is formed on the same layer as the first horizontal driving voltage line 71a, and respective ends of the first connection bridge 71d are partially overlapped on an end of the first vertical driving voltage line 71b and the first external connection line 71c. Therefore, the first connection bridge 71d connects the end of the first vertical driving voltage line 71b and the first external connection line 71c through third contact holes 163 formed in the interlayer insulating layer 160.

Therefore, the first driving voltage applied by the first driving voltage source is transmitted to the first pixel 91 through the first external connection line 71c, the first connection bridge 71d, the first horizontal driving voltage line 71a, and the first vertical driving voltage line 71b.

The second driving voltage line 72 connected to the second pixel 92 that is bigger than the first pixel 91 includes a second horizontal driving voltage line 72a formed to be substantially parallel to the first horizontal driving voltage line 71a, and a second vertical driving voltage line 72b formed be vertical, e.g., above, and to extend in a direction that intersects, e.g., is substantially perpendicular, with respect to the second horizontal driving voltage line 72a.

The second horizontal driving voltage line 72a is formed on the same layer as the first horizontal driving voltage line 71a, and the second vertical driving voltage line 72b is formed on the same layer as the first vertical driving voltage line 71b. Therefore, the interlayer insulating layer 160 is formed between the second horizontal driving voltage line 72a and the second vertical driving voltage line 72b, and the second horizontal driving voltage line 72a is connected to the second vertical driving voltage line 72b through a second contact hole 162 formed in the interlayer insulating layer 160.

A second horizontal connection line 72c is formed on the same layer as the second vertical driving voltage line 72b, the second horizontal connection line 72c is connected to an end of the second vertical driving voltage line 72b, and the second horizontal connection line 72c is formed to be in parallel with the second horizontal driving voltage line 72a. In this instance, the first connection bridge 71d crosses the second horizontal connection line 72c in an insulated manner.

A second external connection line 72e is formed on the same layer as the second vertical driving voltage line 72b, and the second external connection line 72e is connected to an external second driving voltage source (not shown). Therefore, the second external connection line 72e receives a second driving voltage that is less than the first driving voltage from the second driving voltage source.

A second connection bridge 72d is formed on the same layer as the second horizontal driving voltage line 72a, and respective ends of the second connection bridge 72d are partially overlapped on the second horizontal connection line 72c and the second external connection line 72e. Therefore, the second connection bridge 72d connects the second horizontal connection line 72c and the second external connection line 72e through fourth contact holes 164 formed in the interlayer insulating layer 160. In this instance, the second connection bridge 72d crosses the first external connection line 71c in an insulated manner.

Therefore, the second driving voltage applied by the second driving voltage source is transmitted to the second pixel 92 through the second external connection line 72e, the second connection bridge 72d, the second horizontal connection line 72c, the second horizontal driving voltage line 72a, and the second vertical driving voltage line 72b.

Accordingly, the amounts of light transmitting through a modulator 2 for an array test can be controlled to be the same as each other by forming the first driving voltage line 71 and the second driving voltage line 72 for applying the first driving voltage and the second driving voltage that are different from each other on the first pixel 91 and the second pixel 92, respectively.

For this purpose, the first driving voltage line 71 forms the first horizontal driving voltage line 71a and the first vertical driving voltage line 71b, the second driving voltage line 72 forms the second horizontal driving voltage line 72a and the second vertical driving voltage line 72b, which are insulated from each other, and the first driving voltage and the second driving voltage are applied to the first pixel 91 and the second pixel 92, respectively.

Therefore, the organic light emitting diode display 1 including the first pixel 91 and the second pixel 92 that are different in size can detect fine pixel defects by controlling the image screen for the modulator 2 for an array test to be uniform.

A method for testing an organic light emitting diode display according to an exemplary embodiment will now be described with reference to FIG. 3 to FIG. 6.

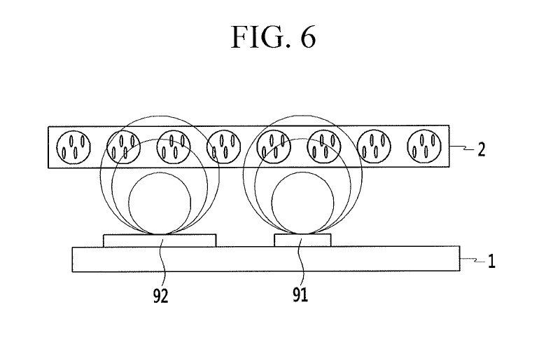

FIG. 6 shows a process for processing an array test by using an organic light emitting diode display according to an exemplary embodiment.

As shown in FIG. 1 to FIG. 5, an organic light emitting diode display 1 according to the exemplary embodiment is manufactured. That is, regarding manufacturing of the organic light emitting diode display 1, a first pixel 91 and a second pixel 92 that is bigger than the first pixel 91 are formed on a substrate 110, and a first driving voltage line 71 and a second driving voltage line 72 for applying a first driving voltage and a second driving voltage that are different from each other are formed on the first pixel 91 and the second pixel 92, respectively.

As shown in FIG. 6, a modulator 2 for an array test is provided above the organic light emitting diode display 1. A second driving voltage that is less than the first driving voltage is applied to the second pixel 92 of the organic light emitting diode display 1 to perform an array test.

Accordingly, the bigger first driving voltage is applied to the small first pixel 91, and the lesser second driving voltage is applied to the big second pixel 92 so an electric field generated by the first pixel 91 can be equivalent to an electric field generated by the second pixel 92. Hence, when slanted angles of liquid crystal inside the modulator 2 for an array test are set to be equivalent, the amounts of light transmitting through the modulator 2 can be set to be equivalent in the first pixel 91 and the second pixel 92 with different sizes.

Therefore, in the organic light emitting diode display 1 having the first pixel 91 and the second pixel 92 with different sizes, fine pixel defects can be detected by controlling the image screen of the modulator 2 to be uniform.

By way of summation and review, an organic light emitting diode display may include a switching transistor, a driving transistor, a capacitor, and an organic light emitting diode (OLED). The driving transistor and the capacitor may be provided with a driving voltage Vdd from a driving voltage line. The driving voltage line may control a current flowing to the organic light emitting diode through the driving transistor. A common voltage line connected to a cathode may supply a common voltage Vss to the cathode to make a current flow by forming a potential difference between a voltage between a source and a drain and the cathode.

During a process for manufacturing the organic light emitting diode display, a test process for reducing the possibility of and/or preventing problematic intermediate products from being further passed on to the next stage may be performed. The test process may be divided into an array test that is performed when a thin film transistor substrate is completed, a cell test that is performed when a panel process is finished, and a module test that is performed when a driving circuit and a backlight unit are assembled.

The array test may use a probe pin or a modulator. For example, the array test may use a probe pin that allows the probe pin to directly contact a gate pad and a data pad, that applies a test signal, and that detects an amount of charge stored in the pixel to analyze disconnection, short circuit, and pixel defects on a thin-film transistor substrate. The test using a modulator applies a test signal to the gate pad and a data pad and analyzes the same by using the modulator provided on the top side of the thin film transistor substrate.

However, when the array test is performed by using the modulator for the organic light emitting diode display with different pixel sizes, the different sizes of the pixels cause different voltages occurring at the pixels and the pixels impart different influences to the liquid crystal inside the modulator for respective pixels. Therefore, the amount of light transmitting through the modulator differs for respective pixels and a video screen of the modulator becomes non-uniform so it is difficult to detect fine pixel defects.

In contrast, the described technology relates to an organic light emitting diode display and a test method thereof. In this regard, the described technology has been made in an effort to provide an organic light emitting diode display for controlling a video screen of a modulator for an array test to be uniform and detecting fine pixel defects in the organic light emitting diode display with different pixel sizes, and a test method thereof.

For example, the organic light emitting diode display, according to the exemplary embodiments, forms the first driving voltage line and the second driving voltage line for applying the first driving voltage and the second driving voltage with different values to the first pixel and the second pixel, respectively, with different sizes to control the amount of light passing through the array test modulator to be equal to each other. Therefore, the video screen of the modulator for the array test in the organic light emitting diode display including the first pixel and the second pixel with different sizes may be controlled to be uniform and fine pixel defects may be detected.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emitting diode display, comprising:
a substrate;
a first pixel and a second pixel on the substrate, the first pixel and the second pixel having different sizes; and
a first driving voltage line and a second driving voltage line connected to the first pixel and the second pixel, respectively, the first driving voltage line being capable of applying a first driving voltage to the first pixel and the second driving voltage line being capable of applying a second driving voltage to the second pixel, wherein:
the second pixel is bigger than the first pixel, and
the second driving voltage is less than the first driving voltage.

2. The organic light emitting diode display of claim 1, wherein the first pixel and the second pixel are of a same size as pixel electrodes formed in the first pixel and the second pixel, respectively.

3. The organic light emitting diode display of claim 1, wherein the first pixel includes a red pixel and a green pixel, and the second pixel includes a blue pixel.

4. The organic light emitting diode display of claim 3, wherein the red pixel and the green pixel are a same size.

5. The organic light emitting diode display of claim 2, further including:
a gate line that applies a gate signal to the first pixel and the second pixel;
an interlayer insulating layer that covers the gate line; and
a data line that crosses the gate line and is on the interlayer insulating layer, and that is capable of applying a data signal to the first pixel and the second pixel, wherein the first driving voltage line includes:
a first horizontal driving voltage line extending in a direction substantially parallel to the gate line, the first horizontal driving voltage line being in a same layer as the gate line; and
a first vertical driving voltage line extending in a direction substantially perpendicular to the first horizontal driving voltage line, the first vertical driving voltage line being in a same layer as the data line.

6. The organic light emitting diode display of claim 5, wherein the first horizontal driving voltage line is connected to the first vertical driving voltage line through a first contact hole formed in the interlayer insulating layer.

7. The organic light emitting diode display of claim 5, further comprising a first external connection line in the same layer as the first vertical driving voltage line, the first connection line being connected to an external first driving voltage source.

8. The organic light emitting diode display of claim 7, further comprising a first connection bridge in the same layer as the first horizontal driving voltage line, the first connection bridge being connecting an end of the first vertical driving voltage line and the first external connection line.

9. The organic light emitting diode display of claim 5, wherein the second driving voltage line includes:
a second horizontal driving voltage line extending in a direction substantially parallel to the first horizontal driving voltage line, the second horizontal driving voltage line being in the same layer as the first horizontal driving voltage line, and
a second vertical driving voltage line extending in a direction substantially perpendicular to the second horizontal driving voltage line, the second vertical driving voltage line being in the same layer as the first vertical driving voltage line.

10. The organic light emitting diode display of claim 9, wherein the second horizontal driving voltage line is connected to the second vertical driving voltage line through a second contact hole formed in the interlayer insulating layer.

11. The organic light emitting diode display of claim 9, further comprising a second horizontal connection line that is in the same layer as the second vertical driving voltage line, that is connected to the second vertical driving voltage line, and that is arranged parallel to the second horizontal driving voltage line.

12. The organic light emitting diode display of claim 11, wherein a first connection bridge crosses the second horizontal connection line in an insulated manner.

13. The organic light emitting diode display of claim 12, further comprising a second external connection line in the same layer as the second vertical driving voltage line and connected to an external second driving voltage source.

14. The organic light emitting diode display of claim 13, further comprising a second connection bridge in the same layer as the second horizontal driving voltage line, the second connection bridge connecting the second horizontal connection line and the second external connection line.

15. The organic light emitting diode display of claim 14, wherein the second connection bridge crosses a first external connection line in an insulated fashion, the first external connection line being in the same layer as the first vertical driving voltage line.

16. A method for testing an organic light emitting diode display, comprising:
manufacturing an organic light emitting diode display in which a first pixel and a second pixel that is bigger than the first pixel are formed on a substrate, and a first driving voltage line and a second driving voltage line for applying a first driving voltage and a second driving voltage with different sizes are formed in the first pixel and the second pixel, respectively;
providing a modulator for an array test on the organic light emitting diode display; and
performing an array test by applying the second driving voltage that is less than the first driving voltage to the second pixel of the organic light emitting diode display.

17. The method of claim 16, wherein the first pixel includes a red pixel and a green pixel, and the second pixel includes a blue pixel.
